(19) United States
(12) Patent Application Publication
(10) Pub. No.: US 2015/0248710 A1
(43) Pub. Date: Sep. 3, 2015

(54) MATCHING USERS ACROSS INDENTIFIABLE SERVICES VASED ON IMAGES

(71) Applicant: ADIENCE SER LTD., Tel Aviv (IL)

(72) Inventors: Alexander MEDVEDOVSKY, Tel Aviv (IL); Roee Nahir, Tel Aviv (IL); Eran Hillel Eidinger, Tel Aviv (IL)

(21) Appl. No.: 14/714,469

(22) Filed: May 18, 2015

Related U.S. Application Data
(63) Continuation-in-part of application No. 14/190,124, filed on Feb. 26, 2014.
(60) Provisional application No. 61/769,240, filed on Feb. 26, 2013.

(51) Int. Cl. G06Q 30/02; G06F 17/30; G06K 9/62

(52) U.S. Cl. CPC G06Q 30/0271; G06K 9/6215; G06F 17/30256

(57) ABSTRACT

A method for determining that a user associated with a first identifiable device or identifiable service is also associated with a second identifiable device or identifiable service by a) generating one or more first image descriptors for one or more first images stored on the first identifiable service associated with a first user, b) generating one or more second image descriptors for one or more second images stored on the second identifiable service associated with a second user, c) calculating, based on the generated first and second image descriptors, the probability that the first user is also the second user. Also provided is a computer readable storage medium containing program code for implementing the method.

### CROSS-REFERENCE TO RELATED APPLICATIONS

This application is a continuation of U.S. patent application Ser. No. 14/190,124, filed Feb. 26, 2014 which claims benefit of U.S. Patent Application No. 61/769,240, filed Feb. 26, 2013, which are hereby incorporated by reference.

### FIELD AND BACKGROUND OF THE INVENTION

The present invention relates to methods and systems for generating insights about people, especially consumers, based on their digital images, user generated content, and metadata.

In content delivery, especially advertising content, understanding one's target audience is crucial. The development of the Internet and in particular Web 2.0 has enabled people to create and share massive amounts of user generated content which can be harnessed to learn valuable insights into the user that generated the content.

In particular digital images, including photos and videos, can potentially offer valuable insight into the person that captured the image, the person(s) viewing or sharing the image, and the person(s) depicted in the image. Thus it is well known in the art to, using computer executed algorithms, analyze user images in order to detect the presence of objects or people that offer insight into a user to for targeted content delivery.

However known methods of performing image analysis to generate user insights do not take advantage of valuable data associated with the image itself, with the device whereon the image was captured or shared, or with the website or app whereon the image was uploaded or shared, all of which can also be analyzed in order to better understand the image for the purposes of creating user insights. In addition, prior art methods do not provide a system where learned insights from an image and/or device can be used to locate additional sources of data, such as additional devices or Internet sites associated with the user. In addition, prior art methods do not take into account user interaction with the customized advertisements or content, or other sources. In addition prior art methods do not look at device time-series data, and the relationships between the “flow” of the content of a user's images, their timing, and context, to truly understand a user.

Thus there is a need for improved methods and systems for using image analysis to generate user insights which overcome these and other shortcomings with the methods and systems known in the art.

### SUMMARY OF THE INVENTION

According to the present invention there is provided a computer implemented method for generating user insights from one or more user images on an identifiable device or identifiable service including: a) receiving, as a first input, one or more image files containing the one or more images; b) receiving, as a second input, at least one of: i. image metadata for at least one of the one or more images, at least one of the image metadata not being embedded in the respective received image file; ii identifiable device metadata from the identifiable device; or iii. identifiable service metadata from the identifiable service; c) analyzing features of the received image files, the feature analysis being based at least in part on at least one of the received second input, and d) generating, based on the feature analysis, at least one user insight for a user associated with the identifiable device or identifiable service.

Preferably, the feature analysis is based on at least one machine learning topology; the second input also includes third party user activity, and the feature analysis is based at least in part on the received third party user activity; the identifiable device metadata includes device static data and device time-series data; and the identifiable service metadata includes user data, user generated data, and first party user activity.

Preferably, the method further includes: locating one or more additional identifiable devices or identifiable services associated with the user; delivering targeted content to the user based on the user insight; and saving the user insight to a user profile associated with the user.

According to the present invention there is further provided a computer implemented method for determining that a user associated with a first identifiable device or identifiable service is also associated with a second identifiable device or identifiable service including: a) generating one or more first image descriptors for one or more first images stored on the first identifiable service associated with a first user, b) generating one or more second image descriptors for one or more second images stored on the second identifiable service associated with a second user, and c) calculating, based on the generated first and second image descriptors, the probability that the first user is also the second user.

Preferably, the step of calculating the probability includes: comparing pairs of first and second image descriptors and calculating similarity scores for each pair, or inputting the first and second image descriptors and a respective indication of a user associated with the first or second image descriptor to a neural network which calculates a similarity score between the first and second users.

According to the present invention there is further provided a computer implemented method for determining a user's identifier on an identifiable service including: a) capturing a user action performed by the user on a first identifiable service where the user action causes user generated content to be added to a second identifiable service; b) monitoring the second identifiable service for events of user generated content being added to the second identifiable service by users of the second identifiable service, each such event of user generated content being associated with a user identifier, and recording the event and the respective user identifier; and c) determining a probabilistic match between the captured user action and one of the one or more monitored events, whereupon if a match is determined, the user is associated with the user identifier recorded for the matched event.

According to the present invention there is further provided a non-transitory computer readable storage medium having computer readable code embodied on the computer readable storage medium, the computer readable code for generating user insights from one or more user images on an identifiable device or identifiable service, the computer readable code including: a) program code for receiving, as a first input, one or more image files containing the one or more images; b) program code for receiving, as a second input, at least one of: i. image metadata for at least one of the one or more images, at least one of the image metadata not being embedded in the respective received image file; ii. identifiable device metadata from the identifiable device; or iii. identifiable service metadata from the identifiable service; c) program code for analyzing features of the received image files, the feature analysis being based at least in part on at least one of the received second input, and d) program code for generating, based on the feature analysis, at least one user insight for a user associated with the identifiable device or identifiable service.

According to the present invention there is further provided a non-transitory computer readable storage medium having computer readable code embodied on the computer readable storage medium, the computer readable code for determining that a user associated with a first identifiable device or identifiable service is also associated with a second identifiable device or identifiable service, the computer readable code including: a) program code for generating one or more first image descriptors for one or more first images stored on the first identifiable service associated with a first user; b) program code for generating one or more second image descriptors for one or more second images stored on the second identifiable service associated with a second user; and c) program code for calculating, based on the generated first and second image descriptors, the probability that the first user is also the second user.

Preferably the program code for calculating the probability includes code for: comparing pairs of first and second image descriptors and calculating similarity scores for each pair, or inputting the first and second image descriptors and a respective indication of a user associated with the first or second image descriptor to a neural network which calculates a similarity score between the first and second users.

According to the present invention there is further provided a non-transitory computer readable storage medium having computer readable code embodied on the computer readable storage medium, the computer readable code for determining a user's identifier on an identifiable service, the computer readable code including: a) program code for capturing a user action performed by the user on a first identifiable service where the user action causes user generated content to be added to a second identifiable service; b) program code for monitoring the second identifiable service for events of user generated content being added to the second identifiable service by users of the second identifiable service, each such event of user generated content being associated with a user identifier, and recording the event and the respective user identifier; and c) program code for determining a probabilistic match between the captured user action and one of the one or more monitored events wherein if a match is determined, the user is associated with the user identifier recorded for the matched event.

### BRIEF DESCRIPTION OF THE DRAWINGS

Various embodiments are herein described, by way of example only, with reference to the accompanying drawings, wherein:

FIG. 1 is a schematic drawing of a computer implemented system for generating user insights from user images and other data;

FIG. 2 is a block diagram of one embodiment of an insight generator according to the present invention;

FIG. 3 is a block diagram of a computer implemented method of matching users across identifiable services;

FIG. 4 is a block diagram of a computer implemented method of determining a user's identity from an interaction with an identifiable service;

FIG. 5 is block diagram of computer system configured to implement the present invention;

### DESCRIPTION OF THE PREFERRED EMBODIMENTS

The principles and operation of a user insight generator according to the present invention may be better understood with reference to the drawings and the accompanying description.

The following terms as used herein should be understood to have the following meaning, unless context or an explicit alternative meaning suggests otherwise:

“Image” or “Digital Image” means a digital representation of a photo or video, including streaming video.

“Image metadata” means surrounding data which is useful for providing contextual information to describe or characterize an image, or properties of an image stored on an identifiable device or identifiable service. Some image metadata may be embedded in the image file itself (e.g. image file headers, EXIF data, geotags, etc.) while other image metadata may be located near the image file (e.g. filename, URL, surrounding text, etc.).

“Identifiable device” means a personal computing device or mobile device (e.g. digital camera or mobile phone) which is associated with a user (which could be the device owner) where the device itself or the user of the device is identifiable by a unique identifier (e.g. device ID, MEID, IMEI, IMSI, telephone number, etc.), including a unique digital footprint such as a combination of hardware signals.

“Identifiable device metadata” means data which describes the state of an identifiable device's radio (e.g. 3G on/off status or service provider, Wi-Fi on/off status or network name/IP etc.), sensor (e.g. gyroscope, accelerometer, etc.) or other signal (e.g. battery level, time since last full charge, installed applications, available storage, etc.) which may be useful for providing contextual information to images captured or stored on the identifiable device. Identifiable device metadata includes “device static data” and “device time-series data”.

“Device static data” means data describing a device radio, sensor, or other signal state at the approximate time the image was captured, stored or modified, usually bounded by several seconds before or after the image was recorded.

“Device time-series data” means data describing a device radio, sensor, or other signal state over time.

“Identifiable service” means a website, app, social networking or cloud service, in which the user of the website (as identified by e.g. a cookie), app, account owner of the social networking or cloud service can be uniquely identified by one or more unique identification means (e.g. a cookie, email address, or login ID including a third party login ID like Facebook Login or OpenID, etc.).

“Identifiable service metadata” means data on an identifiable service on which images are stored which offers information about the user of the identifiable service. Identifiable service metadata includes the following three distinct classes of metadata: “user data”, “user-generated data”, and “first party user activity”.

“User data” means data about the user, such as age or gender, and includes data from a personal profile on the identifiable service.

“User generated data” is content (e.g. comments, texts, images, etc.) created on or uploaded to an identifiable device or identifiable service by the user of the identifiable device or identifiable service (e.g. a user's comment about his own photo), or by another user of the identifiable device or identifiable service when the data created or uploaded impacts the user in some way (e.g. someone else creates a comment about the user's photo).

“First party user activity” is data describing the user's interactions on the identifiable service (e.g. likes, tweets, friends, check-ins etc.) or the interactions of other users on the identifiable service that impact the user (e.g. someone else liking the user's photo).

“Third party user activity” means data describing the user's activity on, or interactions with, a third party identifiable service or identifiable device (e.g. purchase history on Amazon.com, credit reports, telephone records, personal data from linked devices, etc.) in which the third party user is the same, related to, or otherwise associated with, either definitively or by a probability function, a known user of another identifiable device or identifiable service.

“User Generated Content” or “UGC” means user generated data, and first and third party user activity.

Generating User Insights from User Images and Other Data

In one aspect, the invention relates to computer implemented methods and systems for generating user insights for a user based on the user's images and other data. It is contemplated within the present invention that user images may be located on an identifiable device or an identifiable service, and therefore any other data that can be obtained from the identifiable device or the identifiable service may provide useful contextual information to better understand the user's images and therefore the user.

Described herein is a computer implemented “black box” image analyzer which takes as input one or more user images and one or more other data, and generates user insights describing the user based on the user's images as understood at least in part by the one or more other data.

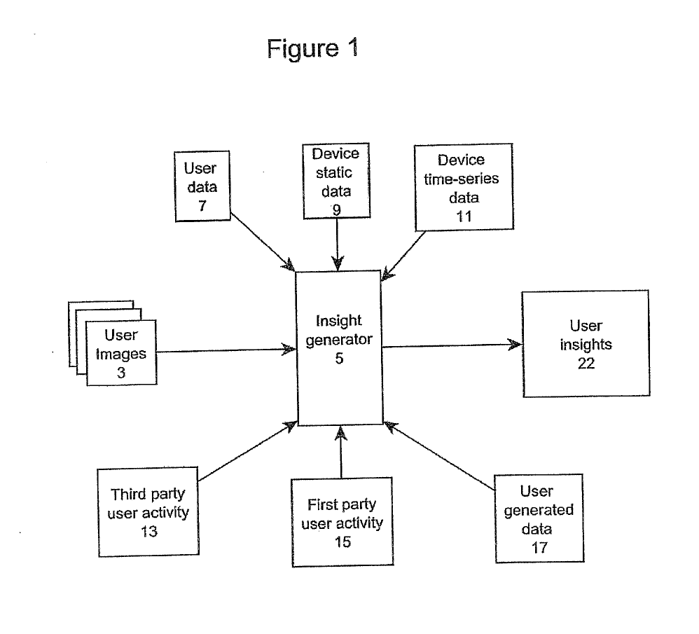

Referring now to FIG. 1, “black box” insight generator 5 receives as input one or more user images 3 from an identifiable device or identifiable service, and one or more of user data 7, user generated data 17, first party user activity 15, third party user activity 13, device static data 9, and device time-series data 11. Insight generator 5 analyzes each of user images 3 based at least in part on the one or more other data, and generates one or more user insights 22 for the user of the identifiable device or identifiable service.

User insights 22 may be described as anything that can be learned, inferred, or deduced about a person. Some non-limiting examples include personal and/or physical characteristics, family status, ethnicity/religion/beliefs, preferences/tastes, interests/hobbies, needs/wants, personal/group/company connections or associations (such as friends, families, work colleagues, or special interest groups), job description, etc.

A user insight 22 may also include a numerical or Boolean value representing the confidence or probability that the user matches or is associated with a known advertising vertical (e.g. a vertical in the OpenRTB standard categories or subcategories) or a predefined advertising vertical or user trait.

In one embodiment user insights 22 may be generated by insight generator 5 “on the fly”, for example when a user requests content which includes targeted content, such as banner ads or targeted news articles. In one embodiment user insights 22 may be generated before a user requests content, or at any other time (e.g. when an image is uploaded), and saved to a database of user profiles which may be queried by a content provider whenever targeted content is required.

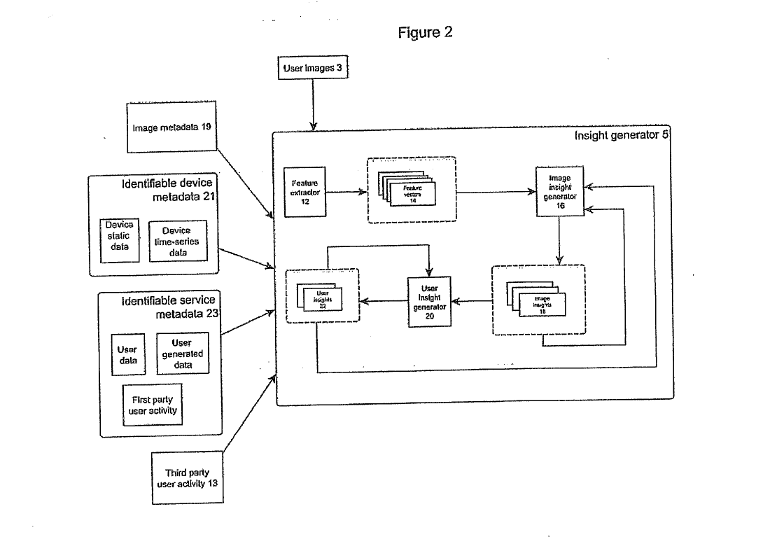

Referring now to FIG. 2, one embodiment of a software-based insight generator 5 according to the present invention will now be described. Insight generator 5 includes a feature extractor module 12, an image insight generator module 16, and a user insight generator module 20. In other embodiments the functions of feature extractor module 12, image insight generator module 16, and user insight generator module 20 may be combined and implemented in a single module, or divided amongst a different number of modules.

Feature extractor 12 analyzes each received user image and outputs one or more feature vectors 14. A feature vector is an array of binary data representing information about the content of the digital image. See for example Aude Oliva, Antonio Torralba, Modeling the shape of the scene: a holistic representation of the spatial envelope, International Journal of Computer Vision, Vol. 42 (3): 145-175, 2001) which describes GIST feature extraction. Other methods of feature vector extraction include SIFT, LBP, HOG, POEM, SURF, or any complicated scheme (see for example Viola, P. et al., “Rapid Object Detection using a Boosted Cascade of Simple Features”, Proceedings of the 2001 IEEE Computer Society Conference on Computer Vision and Pattern Recognition, 2001, pp. I-511-I-518, vol. 1 which describes using a cascade detector to find faces and then calculating a descriptor on the detected faces). Feature vectors 14 are then input to an image insight generator 16 which analyzes feature vectors 14 and, using one or more known algorithms outputs image insights 18 (see for example M. Collins et al, Full body image feature representations for gender profiling, In ICCV workshop, pages 1235-1242, 2009 which describes using a Support Vector Machine (SVM) trained to classify a male/female face or body).

Image insights 18 are digital representations of “insights” or predictions about what the images are about. For example, if feature vectors 14 for a batch of photos indicate lots of white space, image insights 18 might be insights that the photos depict snow to a 65% probability and sky to a 35% probability. Image insights 18 may be general (“The photo is of an urban setting”) or more specific to parts of the photo (“there is a human face in given specific coordinates”), or relative (“these two photos contain the same person, or describe the same scene, approximately”).

Image insights 18 can include insights about: objects depicted in the image (including the number of objects, size, color, form/shape, and in certain cases the identity of specific objects), people (including the approximate age, gender, ethnicity, physical characteristics, clothing or accessories, and in certain cases the identity of specific individuals such as public personalities or persons known to the computer system), animals or insects, brands (e.g. logos on clothing) or branded products (e.g. a Ferrari sports car) located in the image including where applicable specific models, text (e.g. specific words or names, language, fonts, handwriting) including the medium on which the text is printed (e.g. building or computer screen), a geographic location depicted in the image or the location where the image was captured, the type of camera (SLR, compact camera, mobile phone camera) and lens used to capture the image and the camera settings used (flash, point of focus, depth of field, camera preset used such as portrait/landscape/night, exposure time, aperture, etc.), colors prevalent in the image or darkness/lightness of the image, and theme (portrait, nature, macro, architecture, etc.).

Preferably, image insight generator 16 also receives as input one or more image insights 18 which are fed back to image insight generator 16 in a feedback loop to intelligently predict image insights 18 based on experience. For instance, referring back to the example, suppose in a batch of twenty photos fifteen are predicted as containing “snow” over sky to a 65% probability, while five photos are predicted as containing either snow or ski with a 50% probability. Based on past image insights 18 indicative of snow over sky, image insight generator 16 may predict snow for the last five photos. Conversely, if the last five photos indicate sky to a 95% probability, image insight generator 16 may re-analyze the first fifteen photos with a stronger bias towards sky.

Image insights 18 are then input to user insight generator 20 which analyzes image insights 18 and, using one or more known algorithms (e.g. an SVM trained on the number of children appearing in a series of photos and the photo's timestamps, to decide whether a person appearing in the photo is the parent of the children) outputs user insights 22. Referring back to the example above, if image insight 18 suggests the image depicts a person in a snowy scene, user insight 22 might be that the user likes to ski.

Preferably user insights 22 are fed back as input to user insight generator 20 to adjust or refine user insights 22. Preferably user insight generator 20 is pre-programmed with machine learning or other artificial intelligence algorithms to apply knowledge “learned” about the user to predict user insights 22. In one embodiment user insight generator 20 may rank user insights according to a projected confidence level, and may refine, reject, confirm, or vary an assigned confidence ranking as new image insights 18 are received from image insight generator 16.

Preferably, one or more of feature extractor 12, image insight generator 16 and user insight generator 20 also take into account the input image metadata 19, identifiable device metadata 21 and identifiable service metadata 23 in order to better understand user images 3 and generate meaningful user insights 22. For example, if user images 3 are on a user's Facebook account, identifiable service metadata 23 obtained from the user's Facebook account (or another identifiable service linked to the user) might provide data about user's age, “likes”, or celebrities the user follows, thus providing valuable “knowledge” with which to understand the content of user images 3. Referring back to the example, identifiable service metadata 23 may indicate (from e.g. Facebook timeline events, comments, linked hotel reviews, etc.) that the user has vacationed in Colorado. In that case, image insight 18 may be refined further as: “person, snowy scene, maybe Colorado”, and user insight 22 may be refined further to reflect that, e.g. the user probably enjoys ski vacations away from home. To illustrate another example using identifiable device metadata 21, if a user image 3 is a photo which, according to the device charging state at the time the photo was captured, was taken a few minutes after disconnecting from a charger to which it was connected for 6 hours, image insight 18 may include, e.g. that the photo was probably taken in or near the person's home, and user insight 22 might be, for example, that a person depicted in the photo is probably related to the user.

In one embodiment, one or both of image insight generator 16 and user insight generator 20 may also consider third party user activity 13 such as credit bureau data, phone records, or even a restaurant review written by the user found on a restaurant website. Third party user activity 13 can also include for example data from linked devices such as a Smart TV or an electronic fitness bracelet (or even appliances). Third party user activity 13 can also include, for example, “did the user respond well to the ski advertisement” where the third party is an Internet ad provider. If the user responded well to the ski advertisement, the probability that the user is a ski lover (a user insight) is increased. Or, to offer another example, perhaps an image which was previously determined to be either a skiing photo or a photo of something else is now determined to probably be a skiing photo based on the user's likely affinity for skiing.

In some embodiments, the various components or modules that make up insight generator 5 may be physically located on different computer systems. For example, in the case where user images 3 are located on an identifiable device, feature extractor 12 may be located on the identifiable device while image insight generator 16 and user insight generator 20 are located on a remote server. This reduces the bandwidth requirement on the device by only transferring relatively small vector data instead of entire images, and also affords the user a degree of privacy by not requiring the user's images to be transferred off the user's device.

FIG. 2 is just one example of an embodiment of a software-based insight generator 5. In other embodiments, insight generator 5 may be implemented using artificial intelligence topologies such as Deep Neural Nets, Belief Nets, Recurrent Nets, Convolutional Nets, and the like.

### Matching Users Across Identifiable Services Based on Images

A further aspect of the present invention relates to determining when two users of identifiable devices and identifiable services are in fact the same person. For example a person may login to his Facebook account using one username X, and his Twitter account using a different username Y. It would be of great benefit, for the purposes of creating user insights, to know that user X and user Y are in fact the same physical person. Likewise if a user uses a mobile phone identified as phone A (perhaps by IMEI), and a tablet identified as tablet B (perhaps by MEID), it would greatly enhance our understanding of the user if we knew that A and B are owned or operated by the same physical person.

We can determine with a high probability that two users of identifiable devices or identifiable services are in fact the same person if the images (or a subset of images) located on each of the identifiable services or identifiable devices contain an unusually large number of “similarities”. By “similarities” we mean images (or a subset of images) on two or more identifiable devices or services contain similar features (e.g. faces, objects, etc.).

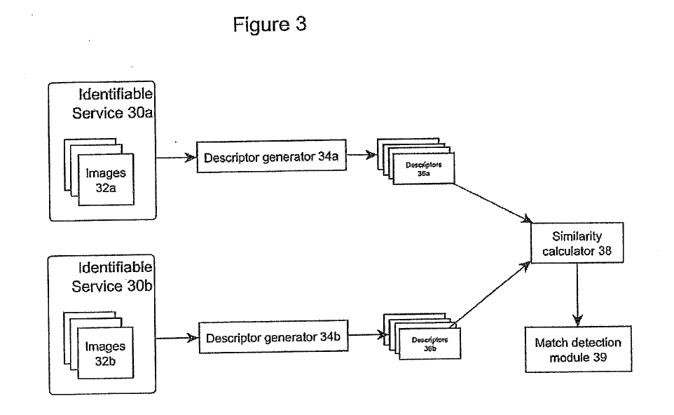

FIG. 3 illustrates a software embodiment of this aspect of the present invention. In FIG. 3, any reference to identifiable service should be understood to include identifiable devices as well. Descriptor generator 34a receives as input one or more images 32a stored on identifiable service 30a. Descriptor generator 34a analyzes each of images 32a and generates as output one or more image descriptors 36a. Descriptor generator 34b receives as input one or more images 32b stored on identifiable service 30b. Descriptor generator 34b analyzes each of images 32b and generates as output one or more image descriptors 36b. Each of descriptors 36a, 36b may be stored in a database along with a unique identifier (such as a username, device ID) identifying the corresponding user or device. Similarity calculator 38 receives as input pairs of descriptors 36a, 36b one each from 34a and 34b, calculates the similarity between the two original images 32a and 32b, and outputs one or more similarity scores which are fed as input to a match detection module 39.

Similarity calculator 38 can be programmed to detect when two images are “similar” in the sense that the two images either: a) are identical or “near” identical images, b) originate from the same image (e.g. one is a sub-image of the other, or each one is a sub-image of a third, or either one of them might be a filtered or processed version of an original image, such as an Instagram “bleach” filter), or c) depict the same subject or object (or class of subjects/objects, e.g. graffiti or buildings) possibly in different settings. Similarity calculator 38 can be programmed to detect some or all of the above similarity “types” between images using methods known in the art.

See for example methods for calculating similarities between images of faces described in Wolf et al. “Descriptor Based Methods in the Wild”, European Conference on Computer Vision (ECCV), (October 2008) which can be generalized for images other than faces, or that described in Chum et al, “Near duplicate image detection: min-hash and tf-idf weighting”, Proceedings of the British Machine Vision Conference 3, p. 4 (2008).

Match detection module 39 analyzes the similarity scores (which could be represented as KN×M matrixes, where K is the number of similarity “types’ being calculated by similarity calculator 38 and N and M are the number of images on identifiable services 30a, 30b respectively) and assigns a probability that a user of identifiable service 30a is the same user as the user of identifiable service 30b. This can be implemented using a Support Vector Machine (SVM) supervised training on a labelled training set, for example, a “same-not-same” SVM, trained to make the calculation of that probabilty, on a supervised labeled set, that receives as input a list of similarity scores, each score pertaining to two images, associated with the two users, AA and BB, from different identifiable services (or devices, or device and service) it is trying to match. The process might be repeated for each candidate user pair, AA and BB, one from identifiable service A and the other from identifiable service B.

While FIG. 3 represents one particular embodiment, many other embodiments are also possible. For example the various modules shown in FIG. 3 may be combined into a single module or divided into a different number of modules, and modules may be located on the same or different physical machines. Modules may be implemented using software, hardware, firmware, or any combination thereof.

In other embodiments, similarity calculator 38 and match detection 39 may combined and implemented using a neural network (such as Deep, Recurrent, Convolutional, or Belief network, or combinations thereof) which takes as input image descriptors and an indication of the user associated with the image represented by the image descriptor, and outputs the probability that the user associated with one set of images is also the user associated with the other set of images.

Determining a User's Identity from an Interaction with an Identifiable Service

Another aspect of the present invention relates to discovering user identity on an identifiable service or device from an interaction with another identifiable service or device.

Websites, mobile applications and the like typically track their users for various purposes. For example, a news site may allow their users to configure the type of news that are interesting to them, and the site may select the news to display to that particular user accordingly. Other sites/apps track their users for targeted advertising purposes: it is beneficial to learn as much as possible information about the user's interests, to remember which ads have been shown to the user, which ads were effective (i.e. the user clicked on them), to know which other sites the user visited lately; to know if he expressed interest in purchasing a specific product on another site; and so on. In this context, it would also be beneficial to know a user's ID on a social networking site or another site with UGC; this information could then be utilized to generate user insights from content on the other site as well as provide targeted content through the other site, as described herein.

A user on a website is typically tracked using cookies although other means can also be used (for example, IP address). A cookie may be set by the website and/or by the website's advertising partner or another 3rd party provider.

Typically a user does not directly provide his ID on a social networking site to the website/app. The site typically does not have rights to set a cookie for the user on the social networking site; therefore it is not straightforward to pair identities. Mobile applications have other means of tracking their users (such as phone number, a file on the device, the phone's SSID, etc.), but the problem remains the same.

Provided herein is a method for determining user's user identifier on an identifiable service or device based on the user's interaction with another identifiable service or device. A user may visit one identifiable service (such a website with a cookie tracker) and interact with it using another identifiable service, such as his social network (Twitter, Facebook, Pinterest, Google+, LinkedIn, Stumble upon, etc.) account. For example, a user may access the website of identifiable service A using his credentials on identifiable service B (although typically identifiable service A does not get access to the actual credentials supplied by the user). This user may “like” (or “share”/“tweet”) a page or other content from identifiable service A. This interaction is typically seen on the user's account on identifiable service B. If we capture the user action on identifiable service A (for example, a click on a “tweet” button) and also monitor updates from a set of users or all the users identifiable service B (or by monitoring notifications), we can match the user action on identifiable service A to a monitored update appearing on identifiable service B and determine that the person that clicked on the “tweet” button on our website is user X on. Twitter. Captured user actions can be matched to instances of monitored updates by timestamp. If numerous such events happen very close to each other, we can conclude that the user, that clicked on the “tweet” button is one of a specific (typically, very small) set of users on the social network site; if the same user generates another interaction such as this with the same social network, we can determine his ID on the network with a very high degree of certainty.

Alternatively, if the user “signs in” to the site/app using his social network account (known as SSO, single sign-on), we may also be able to know the user's identity on the social network from information provided by the social network site or the user during the sign-on process.

Once we have established a connection between the user of a website/app and his social network ID (on one or more network), we can track this user on other sites/apps as well. For example, if an advertising partner/3rd party provider works with the site A and with site B, and we have determined that a user of site A has ID X on a social network site Y, then when the same user visits site B, we know that it is user X on site Y—since as an advertising partner we can track the user on sites A and B using tracking cookies. In the same way, if we have determined the user id X on social networking site Y in a mobile app A, we can then use this information inside other mobile apps.

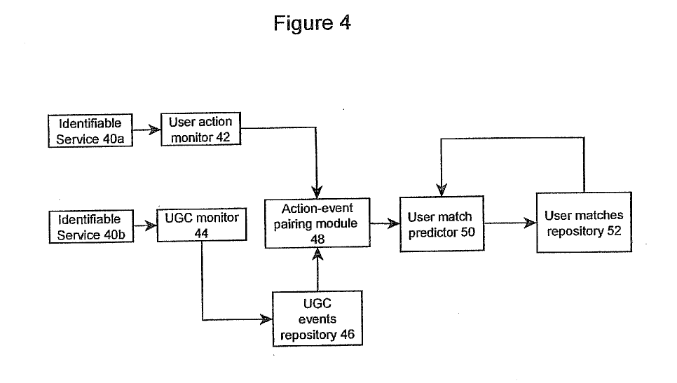

One embodiment of a method for discovering user identity on a website from interaction with another website is shown in FIG. 4. Identifiable service 40a is preconfigured (for example using Javascript) to capture specific types of user actions that interacts with identifiable service 40b, such as clicks to share, tweet, like, etc. Captured user actions are sent to a user action monitor 42 which records the action and timestamp and other identifying information (URL, etc.). A UGC monitor 44 is configured to “listen” to or monitor all UGC updates for all users on identifiable service 40b (using the Twitter Firehose, for instance). UGC updates including the user identifier of the user that created the UGC, as well as the time, are saved in a UGC events repository 46. Search module 48 receives from user action monitor 42 a description of a user action and searches UGC events repository 46 for matching UGC events. Since more than one possible match is possible (this would happen for instance if a number of users “Liked” or “Tweeted” the same CNN.com news article almost instantaneously, for example), user match predictor 50 assesses the probability that a given UGC event is directly attributable to a given user action, and records the probable association in a user matches repository 52.

One method that may be used by user match predictor 50 is as follows. Return a list of possible candidates for matches for user X on identifiable service 40a. This is the set of possible candidates y_k, k=1 . . . K that may have created the UGC on identifiable service 40b. If there is no prior candidate list for user X in user matches repository 52 (i.e. this is the first time an action by user X is being matched) the candidate list is stored in user matches repository 52. Otherwise, user X has already been matched in to a prior candidate list y_m, m=1 . . . M in user matches repository 52.

We can then take the intersection of y_k and y_m (the intersection of two sets will yield a set smaller or equal to the smallest of the two), and store this as the new candidate set in user matches repository 52, y_n, n=1 . . . N, N<=min(M,K), where K>M, K<M, or K=M).

Over time, n would inevitably get smaller as more intersections are recorded. When n=1, we have an exact match. If n>1, we may still have an approximate match, between a user on identifiable service 40a and a set of users on identifiable service 40b.

The following illustrates a simple example. A user Tweets article X on CNN.com at time t1 along with 100 other Twitter users that tweeted article X at the same time. A few days later, however, at time t2 the same user then tweets article Y on CNN.com, at the same time as 50 other users. Of the 50 users that tweeted article Y at time t2, there may be only 10 that also tweeted article X at time t1. By the user's third tweet of article Z at t3, there may be left only a single Twitter user, User 1, that tweeted X at t1, Y at t2. and Z at t3. In the above example, CNN.com may pair the CNN.com cookie with the Twitter ID for User 1.

### Sample Applications of the Insight Generator of the Present Invention

The insight generator of the present invention has application to advertising, market research, customer relations management, and user experience optimization among other possible uses. A number of non-limiting use examples will now be described. In the examples that follow, applications of the user insight generator which discuss photos are also applicable to videos and vice-versa. Video analysis allows better statistical stability, motion detection, and the ability to create time-dependent insights, such as speed, correlation, interactions between objects, etc. All applications of the user insight generator described below featuring mobile phones are also applicable to any device, mobile or stationary, that has a processor, a storage device, and is capable of executing programmable instructions.

### Advertising According to Video Content

On a video-sharing site such as YouTube, for example, analyzing the video content can allow advertising according to the subject of the video. Existing speech-to-text technology can be used to further understand the contents of the video. The advertisement can be placed near the window that plays the video, on the same page, or embedded within the video itself or overlaid on the video within the same window. Or, it can be “saved for later” for the viewing user, and then delivered to him at a later time, on the same website or on another website, in email, or in another way.

### Changing Image Content Based on User Preferences

Image, including video, content can be detected and changed automatically using existing image processing technologies, one of which is described in U.S. Patent Pub. US2013/0094756 entitled “Method and system for personalized advertisement push based on user interest learning to match user preferences”. These preferences may be discovered as described herein, or stated explicitly by the user. As a simple example, if the user prefers red cars, and a photo or video viewed by the user contains a blue car, the car's color can be automatically changed to red. This can be used for advertising, for example, or for improving user experience.

As another example suppose the user is watching a movie in which a car chase is shown involving a black Mercedes. However suppose that a generated user insight based on a user's collection of automobile photos suggests that the user watching the video has a preference for red over black, sports cars over luxury sedans, or Ferraris over Mercedes. In that case, the video can be altered to show a car chase involving a red Ferrari. Alternatively, a billboard featuring a red Ferrari may be added to the scene of the car chase. Alternatively, a commercial featuring a red Ferrari may be inserted into the video just prior to or just subsequent to the scene of the car chase. Alternatively, an ad featuring a red sports car may be placed on the web page next to the video.

### Use in Real-Time Bidding

One application of the user insight generator described above is in real-time bidding (RTB) systems, for example to create a bidding strategy. This can be accomplished by extending existing RTB protocols to include an “interests” tag. For example, when a user is visiting a publisher's website, the publisher can provide information to the ad exchange about the user's interests (as discovered by the methods described herein), so that the exchange can provide the most relevant ads for the user, and each bidder can decide the “value” the bidder places on the user (i.e., how much to bid and which ad to provide). The “interests” tag can be added to the protocols between the RTB supply side platform (SSP) and the ad exchange, and/or the ad exchange and demand side platform (DSP) or any other participants of a RTB system, and may contain a numerical value representing an interest or topic from a predefined list. For example, the numeric representation of “snowboarding” may be “172”, “cat owner” may be “39”, and “vacation in the Caribbean” may be “1192”. If an ad is requested for a user that is a cat owner who may be interested in a Caribbean vacation, the numbers “39” and “1192” may be provided using the “interests” tag. The predefined numbers and the interests they represent may be made available to all the participants in the bidding system. Alternatively textual informative tags can be created instead, for example by an extension to the existing OpenRTB protocol. In addition there may be provided a numerical value representing a confidence level for each interest representing how strong the interest is, or a computed probability that the user has the particular interest. For example, if the described above methods of generating user insights determines that there is a 75% chance the user owns a cat (based on an analysis of the user's data and/or other sources), the number 0.75 (or 75, or any other representation of 75%) may be inserted next to the number “39” in the interest field. The following examples illustrate how the invention described herein may be implemented to aid either or both of a SSP and DSP:

### Example 1

### Aiding a SSP

1. A user visits a web page or uses/visits a mobile application

2. The web page has an embedded call to User Interest Provider (UIP) (such as a “pixel”), or the application has a unique identifier (cookie, Device ID, IMEI, IMSI, phone number, possibly hashed)

3. The UIP checks if the user is known to the system (using a “cookie”, or unique mobile identifier, for example)

4. If the user is new, try to determine the user's identity on a social network, a photo-sharing site, or try to access the user's information in one of the other ways described herein; once this information is found, analyze it to create insights about the user. This stage might be pre-computed by caching and indexing users before they first appear on the SSP so that when the query appears, the data is readily available through an API, SDK or other querying mechanism.

5. If the user is already known to the system, attach the information known about the user to the call sent to the ad exchange by the SSP. For example, if the communication protocol with the Ad Exchange allows selecting tags for requested ad topics from a predefined list of topics, include the topic(s) most relevant to the user.

This example allows the other participants of the RTB process to use the information gathered by the UIP, in order to provide more relevant advertising to the user, thus increasing click-through rate and the website's revenue.

### Example 2

### Aiding a DSP

1. The DSP receives a call from an Ad Exchange about a user visiting a web page or using/visiting a mobile application.

2. The DSP passes the user information to UIP.

3. The UIP checks if the user is known to the system.

4. If the user is new, try to determine the user's identity on a social network, a photo-sharing site, or try to access the user's information in one of the other ways described herein; once this information is found, analyze it to create insights about the user.

5. If the user is already known to the system, pass the user's information to the DSP. Again, this stage might be pre-computed.

6. The DSP can then make a bid on the Ad Exchange using this information.

This example allows the DSP to select/create an advertisement best fitting for the user's interests and needs, and optimize the bidding strategy using all known information about the user. The optimization may be in terms of total campaign cost, cost per click, delivery rate, reach, or any other measurable goals set by the advertising party or client.

### Learning Advertising Effectiveness for a Person

If we have access to a person's advertisement history, e.g. on which ads he has clicked in the past, and which ads successfully convinced him to purchase an item, we can learn his “taste”, especially graphically. For example, we could conclude that ads that have a lot of blue and green and deal with travel work well for Richard, but you need Red and some dogs and kids for Rachel. The results of this learning can be used to: a) better predict effectiveness of a specific ad creative for a specific person, and hence improve advertising effectiveness to this person (therefore increasing CTR and decreasing advertising costs), or b) generation of a custom ad creative to match a specific person's taste or groups of persons, automatically, semi-automatically or manually, and serving these custom ads to these people, thus improving advertising effectiveness.

Statistically Infer Implicit User Preferences from Explicit Ones

We can implement a system that follows users' browsing patterns, engagement with advertisements, and explicitly stated interests (e.g. “likes”), and learns the relationship of these patterns with the users' user generated content, in order to optimize user targeting. For example we may learn that people who “like” hiking or who have albums of ski trips are good advertising targets for energy bars.

### Automatic Selection, Sorting and Tagging of Photos

Understanding the features and elements of a person's images inside a photo-arranging application such as Picasa, and further analyzing usage patterns such as user-related interactions (such as “likes” from friends, or number of views of a picture on a site, etc.) and user-supplied feedback (such as “starring” favorite images) can help to automatically create, filter, order albums, or alter images (better focus, brightness, saturation, crop, etc.), based on user preferences. The discovered user preferences can also be used to improve advertising for the user, improve user experience, and so on.

### Analyzing Photographs in a Computing Device

In this example we concentrate on mobile phones, but a computing device can be a personal computer, a mobile phone, a tablet device, a photo camera, or any device, capable of storing or accessing images and executing instructions. The idea is to analyze the images on a device and then use the insights for advertising or other needs.

A mobile phone application can include a module, capable of analyzing images stored on the device or accessible from the device. This module can analyze the images wholly within the device using its processor, do partial analysis within the device and send the intermediate results to a remote location (such as a server connected to the device via a computer network), or send the images for analysis in a remote location.

For example, the module can find “interest points” (as used in computer vision, see http://en.wikipedia.org/wiki/Interest_point_detection) in some or all images stored on the device, calculate descriptors of the interest points (using SIFT, SURF or any other algorithm), and send these descriptors for analysis on a remote server, together with image files meta-data. The server can then continue the analysis of the images, comparing the received descriptors with predefined descriptors, to detect known objects in these images. The analysis results can be used to learn the device user's interests, and in any other way, as described herein. The discovered information can then be used to advertise products to the user within applications on the same device, or on other devices accessed by the user.

One example of such an advertising scheme is as follows. We create a module with an API, that can be embedded inside an application, that can be executed on the device. The application can be created by a 3rd party, that wants to use the module. The module scans the images stored on the device, or on a storage device connected to the device, or accessible from the device through a network. It analyzes the images, fully or partly, as described above, and sends the results to a designated server, or just sends the images (perhaps after some transformation, such scaled and compressed to reduce bandwidth, or encoded for privacy). The analysis, or data uploading, may be done gradually over time, so as not to use a large amount of computing resources and battery resources at once. It may also be done only while the device is connected to power source, so as not to drain the battery. If the device allows it, it does not necessarily need to be done while the program, containing the module, is running (for example, on Android devices, this can be implemented as a “Service”).

The results of the analysis can be transferred to the remote server immediately after analyzing each image, or stored on the device for transferring at a later time. The results may be transferred when the device is not in active use, or for example when it is connected to a Wi-Fi network, so as not to use a more constrained mobile network.

A second module displays advertisements within the same or another application, in a part of the display designated by the application. It receives the ads to display from a designated remote server. The ads to display are selected partly considering the image analysis performed by the first module.

Both modules transmit to the remote server an identifier of the device or the user, such as: phone number, IMEI, IP number, randomly generated unique identifier, email, ID number or username on a service available in to the user (facebook, twitter, google or such), MAC address of a network card, hash function on the contents of some of the files present on the device, hash function of some of the previous attributes or any of the such, or a combination of thereof.

The two modules may reside inside one application, or they may reside in different applications, possibly created by different 3rd parties. They may also reside on different devices. The identifying information sent by the first module is matched with that of the second module on a remote server, and the image analysis results sent by the first module are used to select ads to display within the second module. The two modules may be bundled together as one package, or separately.

A variation on this scheme is that the first module transmits the results to a designated server, which completes the analysis of the user, perhaps together with information available from other sources. This information about the user, in forms of tags, code words or in any other form usable within a computer system, is transmitted to another server, for use in advertisements targeting the same user, or for market research, statistics, or any other purpose. The information may be provided as statistics on a group of users (13% of the users in the group have cats, 27% are skiers etc.).

In addition to mentioned above, the module can analyze text information present on the device or accessible from the device. For example: file names, contact names, messages content, image descriptions, etc., can also be analyzed on the device or sent to the remote server for analysis.

### Application Programming Interface (API)

The described insight generator may be implemented as an API for third party applications. For example, a server can be configured to allow remote execution of a function, which accept as a parameter an image or a set of images (by their URL or any other way), and returns a list of objects/brands/persons (etc., as described in section 3) in the picture. Or, the function can accept a person's ID on a social network site (possibly in combination with a “security token”, which allows access to the user's information on the site), and returns insights about that person—what he likes, needs, has, may be interested in, etc., as described. Alternatively, the function may return an advertisement relevant to the user (selected or generated from a pool of advertisements).

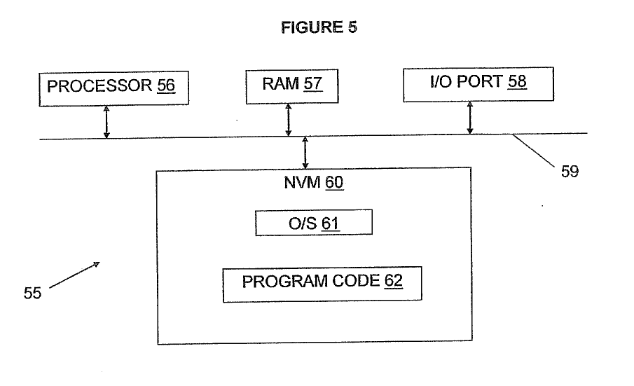

FIG. 5 is a high-level partial block diagram of an exemplary computer system 55 configured to implement the present invention. Only components of system 55 that are germane to the present invention are shown in FIG. 5. Computer system 55 includes a processor 56, a random access memory (RAM) 57, a non-volatile memory (NVM) 60 and an input/output (I/O) port 58, all communicating with each other via a common bus 59. In NVM 60 are stored operating system (O/S) code 61 and program code 62 of the present invention. Program code 62 is conventional computer executable code designed to implement the present invention. Under the control of OS 61, processor 56 loads program code 62 from NVM 60 into RAM 57 and executes program code 62 in RAM 57 to perform the functions of the present invention as described fully above.

NVM 60 is an example of a computer-readable storage medium bearing computer-readable code for implementing the data validation methodology described herein. Other examples of such computer-readable storage media include read-only memories such as CDs bearing such code, or flash memory.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A computer implemented method for determining that a user associated with a first identifiable device or identifiable service is also associated with a second identifiable device or identifiable service comprising:
a) generating one or more first image descriptors for one or more first images stored on the first identifiable service associated with a first user,
b) generating one or more second image descriptors for one or more second images stored on the second identifiable service associated with a second user,
c) calculating, based on said generated first and second image descriptors, the probability that said first user is also said second user.

2. The method of claim 1 wherein the step of calculating said probability comprises:
comparing pairs of first and second image descriptors and calculating similarity scores for each said pair.

3. The method of claim 1 wherein the step of calculating said probability comprises:
inputting said first and second image descriptors and a respective indication of a user associated with said first or second image descriptor to a neural network which calculates a similarity score between said first and second users.

4. A non-transitory computer readable storage medium having computer readable code embodied on the computer readable storage medium, the computer readable code for determining that a user associated with a first identifiable device or identifiable service is also associated with a second identifiable device or identifiable service, the computer readable code comprising:
a) program code for generating one or more first image descriptors for one or more first images stored on the first identifiable service associated with a first user;
b) program code for generating one or more second image descriptors for one or more second images stored on the second identifiable service associated with a second user; and
c) program code for calculating, based on said generated first and second image descriptors, the probability that said first user is also said second user.

5. The medium of claim 4 wherein said program code for calculating said probabilty includes code for: comparing pairs of first and second image descriptors and calculating similarity scores for each said pair

6. The medium of claim 4 wherein said program code for calculating said probabilty includes code for: inputting said first and second image descriptors and a respective indication of a user associated with said first or second image descriptor to a neural network which calculates a similarity score between said first and second users.
